(19) United States
(12) Patent Application Publication
(10) Pub. No.: US 2024/0364504 A1
(43) Pub. Date: Oct. 31, 2024

(54) Reliable On-Demand Destruction of Cryptographic Keys

(71) Applicant: Google LLC, Mountain View, CA (US)

(72) Inventor: Aubrey Douglass Alston, Englewood, NJ (US)

(21) Appl. No.: 18/482,313

(22) Filed: Oct. 6, 2023

Related U.S. Application Data
(60) Provisional application No. 63/498,925, filed on Apr. 28, 2023.

(51) Int. Cl. H04L 9/08

(52) U.S. Cl. CPC H04L 9/085; H04L 9/0894

(57) ABSTRACT

Example embodiments of the present disclosure provide for an example method including obtaining data include an erasure scope parameters. The erasure scope parameters include a binding key and a scope timer. The example method includes obtaining resource data. The example method includes encrypting the resource data using the binding key. The example method includes obtaining a shred-now request. The example method includes in response to obtaining the shred-now request, deleting the binding key and rendering the encrypted data unrecoverable.

### PRIORITY

The present application claims the benefit of priority under 35 U.S.C. § 119 to U.S. Provisional Patent Application No. 63/498,925, filed Apr. 28, 2023, which is hereby incorporated by reference herein in its entirety.

### FIELD

The present disclosure relates generally to destruction of cryptographic keys. More particularly, the present disclosure relates to erasure of globally distributed keys and data on-demand.

### BACKGROUND

Data is often protected by one or more data encryption keys, which are encrypted by some high-value primary key. As a result, the ciphertext takes on properties determined by the key. For example, ciphertext is subject to access control applied to the high value primary key. The role of the high-value master key has traditionally been played by keys which are reliably confidential, durable, and available.

### SUMMARY

Aspects and advantages of embodiments of the present disclosure will be set forth in part in the following description, or can be learned from the description, or can be learned through practice of the embodiments.

In some aspects, the present disclosure provides for an example computer-implemented method for reliable on-demand destruction of cryptographic keys. The example method includes obtaining data including erasure scope parameters. The erasure scope parameters include a binding key and a scope timer. The example method includes obtaining resource data. The example method includes encrypting the resource data using the binding key. The example method includes obtaining data indicative of a shred-now request. The example method includes deleting, in response to obtaining the shred-now request, the binding key.

In some aspects, the present disclosure provides for an example computing system for reliable on-demand destruction of cryptographic keys including one or more processors and one or more memory devices storing instructions that are executable to cause the one or more processors to perform operations. In some implementations the one or more memory devices can include one or more transitory or non-transitory computer-readable media storing instructions that are executable to cause the one or more processors to perform operations. In the example system, the operations can include obtaining data including erasure scope erasure scope parameters. The erasure scope parameters include a binding key and a scope timer. The operations include obtaining resource data. The operations include encrypting the resource data using the binding key. The operations include obtaining data indicative of a shred-now request. The operations include deleting, in response to obtaining the shred-now request, the binding key.

In some aspects, the present disclosure provides for an example transitory or non-transitory computer readable medium embodied in a computer-readable storage device and storing instructions that, when executed by a processor, cause the processor to perform operations. In the example transitory or non-transitory computer readable medium, the operations include maintaining a logical treadmill of multiple unique encryption keys that are made available and destroyed according to a predetermined schedule. Each of the unique encryptions have an associated deletion timestamp. In the example transitory or non-transitory computer readable medium, the operations include providing an interface that grants cryptographic oracle access to the encryption keys on the treadmill using a logical treadmill. In the example transitory or non-transitory computer readable medium, the operations include obtaining, by a computing system, data including an erasure scope parameters. The erasure scope parameters include (i) a binding key including an ephemeral key that is specific to the erasure scope parameters and (ii) a scope timer. The scope timer includes an indication of a duration of time for which resource data should be accessible. The binding key used to encrypt the data is selected from the logical treadmill based on an amount of time remaining between a current time and the deletion timestamp, the amount of time remaining corresponding to the scope timer. In the example transitory or non-transitory computer readable medium, the operations include obtaining, by the computing system, the resource data. In the example transitory or non-transitory computer readable medium, the operations include encrypting the resource data using the binding key. In the example transitory or non-transitory computer readable medium, the operations include obtaining data indicative of a shred-now request. In the example transitory or non-transitory computer readable medium, the operations include deleting, in response to obtaining the shred-now request, the binding key.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example block diagram for reliable on-demand destruction of cryptographic keys.

FIG. 2 depicts an example flow diagram for reliable on-demand destruction of cryptographic keys.

FIG. 3 depicts a flow chart diagram of an example method for maintaining a cryptographic treadmill for use in reliable on-demand destruction of cryptographic keys according to aspects of the present disclosure.

FIG. 4 depicts a flow chart diagram of an example method for determining execution of a shred-now command for reliable on-demand destruction of cryptographic keys according to aspects of the present disclosure.

FIG. 5 depicts a schematic diagram of example logical treadmill for encryption according to aspects of the present disclosure.

FIG. 6 depicts a schematic diagram of example logical treadmill for encryption according to aspects of the present disclosure.

FIG. 7 depicts a schematic diagram of example logical treadmill for encryption according to aspects of the present disclosure.

FIG. 8 depicts a schematic diagram of example logical treadmill for encryption according to aspects of the present disclosure.

FIG. 9 depicts a block diagram of an example system for reliable on-demand destruction of cryptographic keys.

FIG. 10 depicts an example block diagram of a system for reliable on-demand destruction of cryptographic keys.

### DETAILED DESCRIPTION

The present disclosure provides for reliable on-demand destruction of cryptographic keys. In computing systems, particularly cloud-based computing systems, large volumes of data and cryptographic keys can be copied and distributed an unknown number of times globally. Existing technologies allow for destruction of cryptographic keys as of a set expiration time but fail to allow for erasure of globally distributed keys and data on-demand. Existing technologies also fail to delete as strongly, cannot delete data within precise timing constraints, or require frequent storage modifications. The present disclosure allows for large scale crypto-shredding (e.g., deleting data by intentionally overwriting the encryption keys) at a large scale unachievable by existing technologies.

The large volumes of data can be bound to user-defined erasure scope parameters that associate a binding key and scope timer with the dataset. Cryptographic keys can be used to encrypt and later decrypt the data and there is a need for destruction of the cryptographic keys. Existing technologies are limited to destroying the cryptographic keys as of a set expiration time for the key. Storing the keys and associated data can utilize large amounts of memory. However, there can be instances where a cloud computing system is finished using a particular data set and thus can free up the memory associated with that data before the set expiration time. Current methods do not allow for the destruction of the cryptographic keys at a time that is earlier than the set expiration time.

The present disclosure provides for a solution by allowing on-demand destruction of cryptographic keys to ensure deletion of the large amounts of data across various devices and freeing up additional memory for new erasure scope parameters to be defined or associated with new data. Aspects of the present disclosure address the above deficiencies by providing a reliable on-demand destruction of cryptographic keys.

With reference now to the figures, example embodiments of the present disclosure will be discussed in further detail.

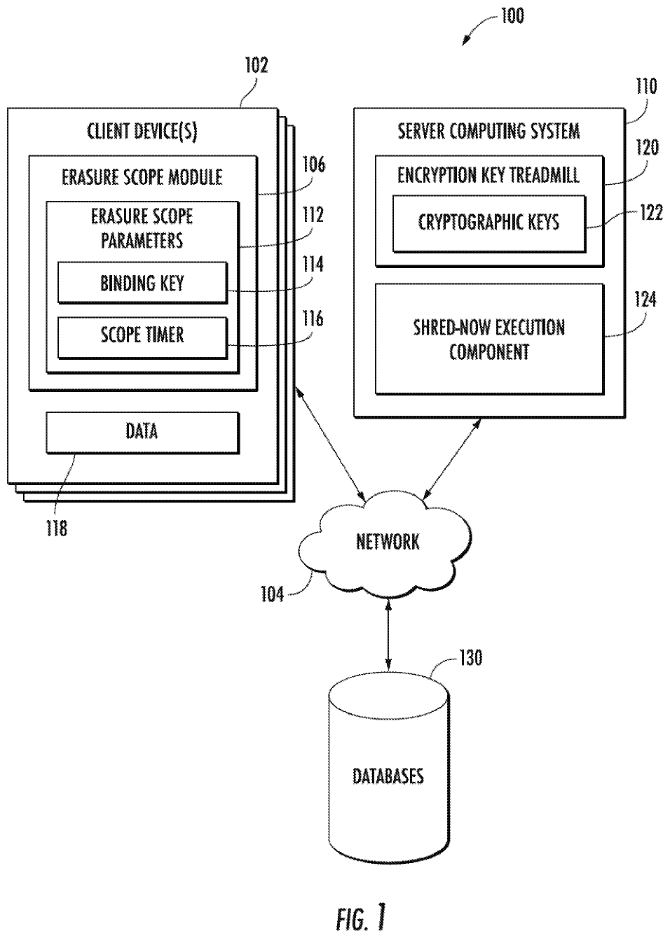

FIG. 1 depicts a block diagram of an example system architecture 100 for allowing on-demand destruction of cryptographic keys according to embodiments of the present disclosure. System architecture 100 can depict an example cloud system architecture. For instance, the computing system architecture 100 can include one or more client devices 102 or databases 130 communicatively coupled over network 104 to server computing system 110. Client devices 102 can communicate data over network 104 to server computing system 110 to generate erasures scopes or perform operations which result in generation of a shred-now request. The shred-now request can be transmitted over network 104 to the server computing system and received by shred-now execution component 124 which can initiate a shred-now operation. The shred-now operation can render any data bound to the erasure scope in accessible by destroying a binding key associated with the erasure scope.

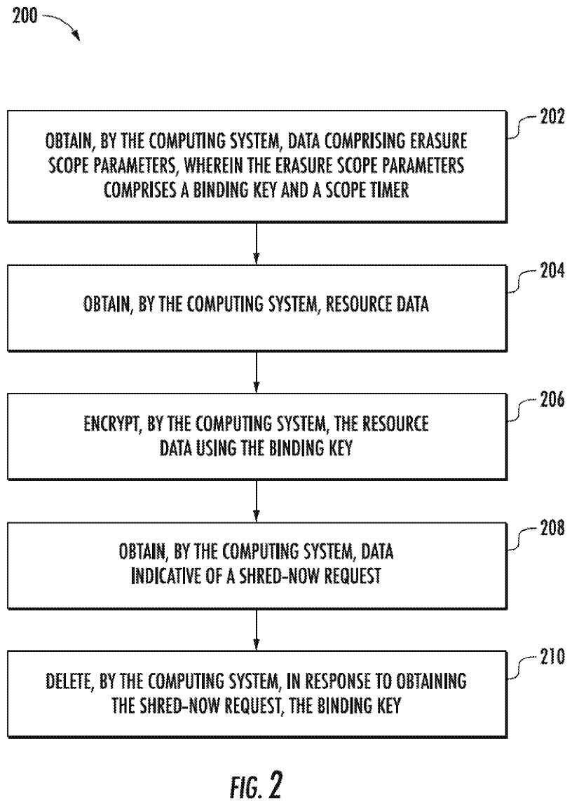

For instance, client device 102 can store and manage erasure scope parameters 112 via erasure scope module 106. Erasure scope module 106 can associate data 118 with erasure scopes using erasure scope parameters 112. Erasure scope parameters 112 can include a binding key 114, a scope timer 116, and data 118. The binding key 114 can be an ephemeral cryptographic key that is specific to the erasure scope parameters and derived from a cryptographic key of cryptographic keys 122 associated with encryption key treadmill 120 (e.g., a logical treadmill). For instance, binding key 114 can be derived from, or encrypted by one of cryptographic keys 122. The binding key 114 of an erasure scope can be used to encrypt data 118. (e.g., as described in FIG. 2). The encrypted data can be bound to the erasure scope by nature of being encrypted by binding key 114. Binding key 114 can include a scope timer 116 which can contain information about the generation and expiration of the binding key 114.

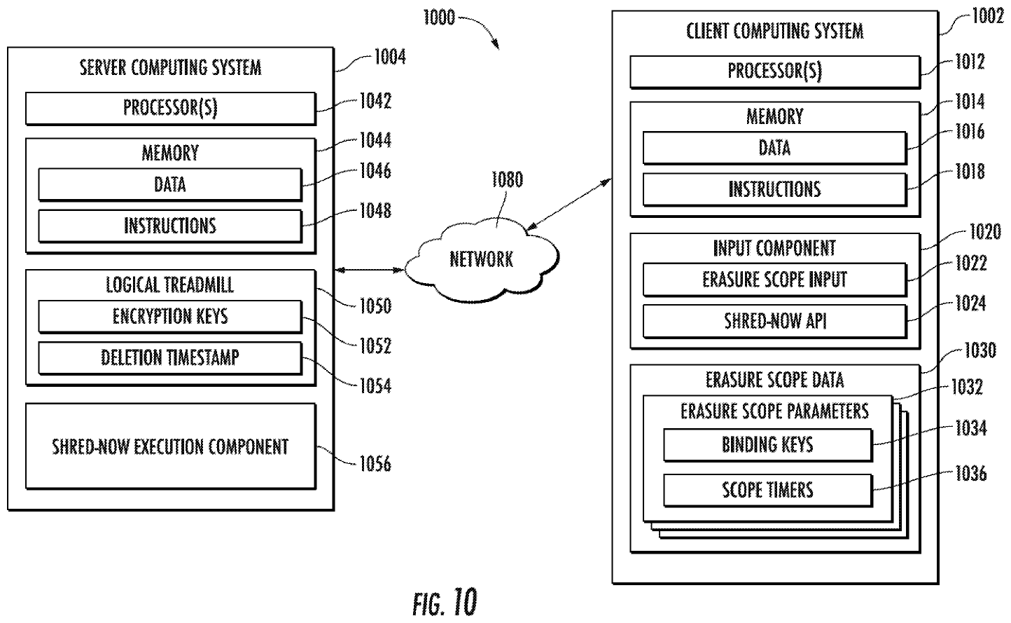

The scope timer 116 can include one or more times associated with the share origin, share reconstruction, share expiration, or tentative reclamation time of the erasure scope parameters 112. In some implementations the binding key 114 can be split with secret sharing and stored in memory in a one or more of locations (e.g., as described in FIG. 9). The erasure scope parameters 112 can be bound to a set of data 118. For instance, data 118 can be data associated with a specific user or client device 102. Additionally, or alternatively, data 118 can be some other group of data, such as intermediate data in a cloud system data processing pipeline. Data 118 can be encrypted with binding key 114 which can be derived from or encrypted by a cryptographic key of cryptographic keys 122. The binding key 114 can be deleted on-demand by the server computing system performing a shred-now operation which destroys the cryptographic key of cryptographic keys 122 that is associated with binding key 114. This renders binding key 114 and the data 118 encrypted by binding key 114 unrecoverable (e.g., as described in FIG. 9).

In an example embodiment, erasure scope module 106 can be accessed via a user interface of client device 102 for a user to provide input provisioning an erasure scope and associated erasure scope parameters 112 or initiating a shred-now request. For instance, the server computing system 110 can obtain data indicative of user input including user provisioned erasure scope parameters.

In some example embodiments, a shred-now request can be automatically initiated following performance of a trigger event. For instances, a trigger event can include completion of processing intermediate data bound to an erasure scope.

An example use case of the described technology is in data processing pipelines, for instance, in cloud computing. As described herein, cloud computing systems can generate intermediate data as part of overall data processing pipelines. As data flows through a cloud computing system, it can undergo transformations or computations. The operations can produce intermediate results or data that serve as temporary representations of the data at the different stages of processing. The intermediate data can be used at later steps in the data processing pipeline to be used for optimizing performance, determining fault tolerance, or scaling the system. In some instances, the intermediate data can be cached to reduce redundant computations and increase processing efficiency.

An erasure scope can be created for each set of intermediate data. For instance, part of the data processing pipeline can include generating a new erasure scope for each set of intermediate data. Upon completion of use of the set of intermediate data, transmission of a request for shred-now for the data can be sent to the server computing system and processed by shred-now execution component 124. This is one example of an automatic generation of an erasure scope and triggering of a shred-now request.

Additionally, or alternatively, an erasure scope can be manually generated by user providing input via a user interface of client device 102. For instance, the erasure scope parameters 112 can be stored or managed via client device 102. In some instances, generation of erasure scopes and associated erasure scope parameters 112 can be automatically generated or generated based on user input. Similarly, generation of a shred-now request can be automatically generated or generated based on user input.

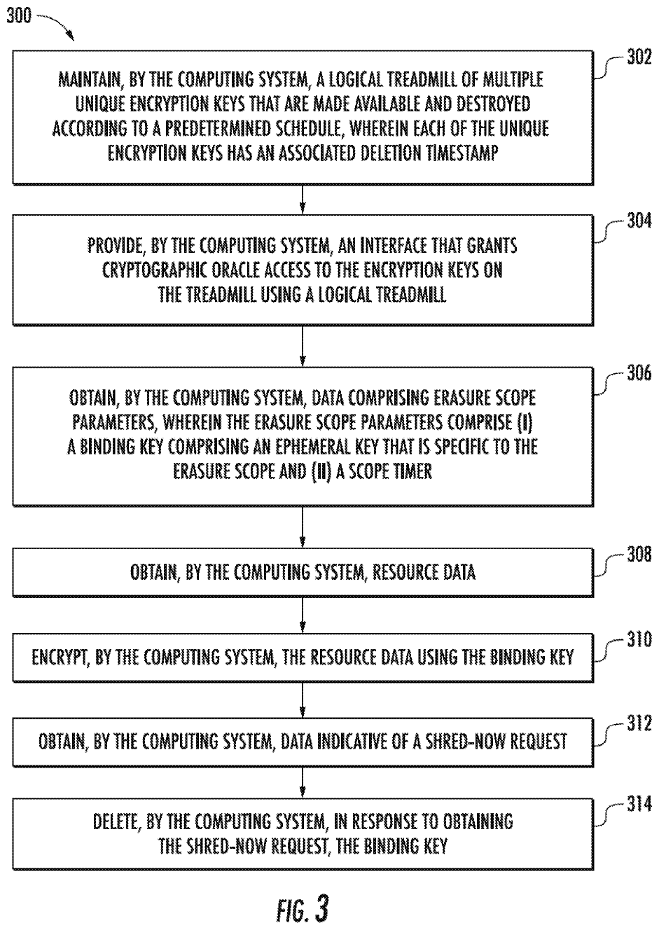

Server computing system 110 can maintain an encryption key treadmill 120 which can create and destroy cryptographic keys 122 as described in FIG. 3 and FIG. 5 to FIG. 8. The cryptographic keys 122 can be used to derive or encrypt binding keys, such as binding key 114. Responsive to obtaining data to trigger a shred-now command (e.g., a shred-now request), shred-now execution component 124 can perform a shred-now operation. For instance, server computing system 110 can obtain data indicative of a shred-now request for a specified erasure scope. As described herein, the shred-now request can be automatically generated in response to a trigger or can be obtained from user input (e.g., via erasure scope module 106). In response, server computing system 110 can perform a shred-now operation via shred-now execution component 124. The shred-now operation can include locating the cryptographic key of cryptographic keys 122 that is associated with binding key 114 (e.g., was used to derive or encrypt binding key 114) on encryption key treadmill 120 and writing over the cryptographic key of cryptographic keys 122 with random data. For instance, binding key 114 can be rendered un-decryptable due to the destruction of the associated cryptographic key of cryptographic keys 122. This can render binding key 114 unrecoverable and thus result in the data bound to the erasure scope parameters being computationally infeasible to recover (e.g., delete the associated data).

Databases 130 can store data such as data encrypted by a binding key. For instance, databases 130 can store data 118 that has been encrypted by binding key 114. In some instances, databases 130 can store intermediate data as described herein. Additionally, or alternatively, databases 130 can store cryptographic keys 122, binding keys 114, or data associated with scope timer 116. Databases 130 can be accessed by client devices 102 or server computing system 110 over network 104.

FIG. 2 depicts a flow diagram of an example method to perform reliable on-demand destruction of cryptographic keys according to example embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run on or executed on a processing device), or a combination thereof. In some embodiments, the method 200 is performed by the shred-now execution component 124. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, processing logic can obtain data including an erasure scope parameters. The erasure scope parameters can include a binding key and a scope timer. The erasure scope parameters can be a user provisioned erasure scope parameters. For instance, a client computing system can obtain data indicative of a request to create an erasure scope for a set of data (e.g., an automatically generated request, a request provided via user input). In some instances, the set of data can be an existing set of data. Additionally, or alternatively, the set of data can be data that is generated after the binding key is selected. The binding key can be a binding key associated with an encryption key treadmill of the server computing system. As described herein, the binding key can include an ephemeral key that is specific to the erasure scope parameters. The scope timer can include an origin deadline, a reconstruction deadline, a share expiration, and a tentative reclamation.

In some implementations, the binding key can be stored across a one or more of devices by distributing a binding key secret share to each device of the one or more of devices. In some implementations, the binding key can be stored across a one or more of server processes that can take place on one device or multiple devices. The encrypted binding key share can include a key identifier and an expiration time.

The erasure scope parameters can be defined by an erasure scope parameters namespace. The erasure scope parameters namespace can include an identification of one or more authorized user devices to transmit shred-now requests or a storage policy associated with one or more storage locations associated with secret sharing of the binding key. The authorized users can be provisioned by data indicating which client devices should have access to allocate or delete erasure scopes and associated data. In some instances, authorized user devices can be determined based on an authentication process. The storage locations associated with secret sharing of the binding key are discussed further in FIG. 9.

In some example implementations, the binding key can be stored across n number of devices. In order to unwrap the data that has been encrypted by the binding key, n/2+1 of the n number of devices (or server processes) must be accessible. For instance, over half of the devices, or server processes, that contain distinct shares of the binding key must be accessible in order to reconstruct the binding key. The binding key must be reconstructed before the expiration time associated with the scope timer in order to perform an unwrap operation to decrypt the data that was encrypted by the binding key.

The erasure scope parameters can be stored in a bit layout including the scope timer and the encrypted binding key share. For instance, the bit layout can be a serialized data structure.

The scope timer can include a time to live (TTL). The shred-now request can be received before the TTL. For instance, the TTL can be a TTL that is custom to that erasure scope parameters. Alternatively, the TTL can be a system default TTL that is part of any binding key generated by an encryption key treadmill associated with the system.

In some instances, the server computing system can determine, based on the scope timer, that the erasure scope parameters needs a binding key that is available for a certain length of time (e.g., minutes, hours, days, etc.). The server computing system can determine that an existing key is close to an expiration time or is no longer in use (e.g., is available for reclamation). In response, the computing system can generate a new cryptographic key via encryption key treadmill with an expiration time that aligns with the user-provisioned availability time. The server computing system can transmit the cryptographic key to be used as the binding key, and the client device can store the erasure scope parameters associated with that client device. For instance, the erasure scope parameters can be stored in an erasure scope parameters namespace.

In some instances, the computing system can determine that an existing cryptographic key on encryption key treadmill is not associated with an erasure scope parameters or bound to data. The computing system can determine that the erasure scope bounds associated with the provisioned erasure scope parameters can be satisfied by the existing cryptographic key. In response, the server computing system can determine that the existing cryptographic key is the binding key. The server computing system can transmit the cryptographic key to be used as the binding key, and the client device can store the erasure scope parameters associated with that client device. The server computing system can store the cryptographic keys across multiple devices (e.g., as described in FIG. 9).

At operation 204, processing logic can obtain resource data. For instance, resource data can include data (e.g., data 118) that should be bound to the erasure scope parameters (e.g., erasure scope parameters 112). Resource data can be data associated with a user identifier or client device. In some instances, a client device and server computing system can be associated with a private pipeline service (e.g., a cloud computing service). The private pipeline service can process client device data and generate intermediate data at various points in the private pipeline. The generated data can be associated with the erasure scope parameters of the client. Thus, when a shred-now request for the erasure scope parameters is received the data associated with the erasure scope parameters can be crypto-shredded.

At operation 206, processing logic can encrypt the resource data using the binding key. As described herein, the resource data can be bound to the erasure scope parameters through a wrap/unwrap interface. By way of example, the computing system can obtain a request allocate an erasure scope parameters to a particular set of data. The request for allocation can be generated automatically or responsive to obtaining user input. The server computing system can locate the binding key associated with the erasure scope parameters (in some instances the binding key must be reconstructed by a distributed erasure scope parameters backing system) and can wrap the data with the encryption key. Before the expiration time associated with the scope timer, the secret shares of the binding key can be obtained to reconstruct the binding key and the associated data can be unwrapped (e.g., unencrypted or reconstructed).

Encrypting the resource data using the binding key can include locating one or more binding key secret shares; reconstructing the binding key; and encrypting the resource data using the binding key. In some instances, the resource data is encrypted as it is created. For instance, in an example private pipeline service, as intermediate data is generated it can be encrypted with the binding key associated with the erasure scope parameters. Thus, the encrypted resource data will be crypto-shredded, at the latest, at the time of the expiration of the binding key or, at the earliest, upon receipt of a shred-now request.

In some implementations the distributed system is performed using secret sharing. The secret sharing can include Shamir's Secret Sharing. For instance, the key can be stored in memory (e.g., RAM) in three or more locations. Shamir's secret sharing is a process used to secure a secret in a distributed form. The secret can be split into multiple shares, which individually do not give any information about the secret. To reconstruct the secret, a threshold number of shares is needed. For instance, the threshold number of shares can be n/2+1 shares of n shares. So, for instance, if there are 3 shares, the threshold would be 2 shares, if there are 4 shares, the threshold would be 3 shares, and so on. Thus, without access to the threshold number of shares the secret can have a property of perfect secrecy. This level of security can be information-theoretic security, which requires an attacker to have above a threshold (e.g., a quorum) of the shares to uncover the secret (e.g., private information).

At a time of encryption, the computing system can obtain user input indicative of an erasure scope parameters. The computing system can locate each of the split binding key shares and reconstruct the binding key. The computing system can encrypt a data set using the binding key. This process can bind the encrypted data to that specific erasure scope parameters.

At a later time, before the set expiration time associated with the binding key (e.g., set by the encryption key treadmill), the computing system can obtain a shred-now remote procedure call (RPC). The shred-now RPC can include the specific erasure scope parameters that is to be deleted. The secret shares associated with the binding key that is associated with the erasure scope parameters can be located and written over with random data. This writing over with random data results in an unrecoverable binding key, and thus renders any data associated with the erasure scope parameters computationally infeasible to recover.

In some implementations, this feature can allow for long-running distributed computing pipelines to be preempted such that the computing system loses access to all intermediate data within minutes, seconds, or milliseconds. Further, implementations can allow for the long-running distributed computing pipelines to configure longer TTLs while maintaining compliance so long as the shred-now request is issued after pipeline completion.

At operation 208, processing logic can obtain data indicative of a shred-now request. For instance, the shred-now request can be a request obtained from a client device for a shred-now operation to be initiated. As described herein, a client device can obtain user input indicative of a shred-now request. Additionally, or alternatively, a shred-now request can be generated responsive to the completion of a task. For instance, erasure scopes can be utilized in the context of private pipeline service. The private pipeline can be associated with a one or more of client devices. In some instances, each client device can have a respective associated erasure scope. The private pipeline service can determine that an entire pipeline process associated with erasure scope parameters has been completed and that data (e.g., including intermediate generated data) is no longer needed. In response to determining that the process has completed, and the data is no longer needed, the binding key associated with the erasure scope parameters can be deleted. The memory associated with the erasure scope parameters and associated data can be marked as available for reclamation based on the deletion of the binding key and associated data.

At operation 210, processing logic can delete, in response to obtaining the shred-now request, the binding key. As described herein, deleting the binding key can be a hard cryptographic deletion. For instance, the binding key can be located and written over with random data. By writing over the binding key with random data, the binding key is unable to be reconstructed and thus the data that has been encrypted with the binding key is incapable of being unwrapped or unencrypted. In some instances, this deletion is so strong that another party would have to guess what the data is in order to access the data. Thus, this method results in a strong on-demand deletion across a distributed system.

In some implementations, the binding key is split over one or more binding key secret shares. Performing deletion of the binding key can include locating one or more binding key secret shares and writing over the one or more binding key secret shares storage location with random data. Deleting the binding key (or binding key secret shares) can result in the binding key being computationally unrecoverable.

FIG. 3 depicts a flow diagram of an example method to maintain a cryptographic treadmill for use in on-demand destruction of cryptographic keys according to example embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run on or executed on a processing device), or a combination thereof. In some embodiments, the method 300 is performed by the server computing system 110 or server computing system 1004. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, processing logic can maintain a logical treadmill of multiple unique encryption keys that are made available and destroyed according to a predetermined schedule, wherein each of the unique encryption has an associated deletion timestamp.

As described herein, maintaining a logical treadmill can include comparing the deletion timestamp for each respective encryption key to a current time. Maintaining the logical treadmill can include removing a given key from the logical treadmill when the deletion timestamp is equivalent to or later than the current time. In some instances, the encryption keys can be made available according to a first predetermined schedule and destroyed according to a second predetermined schedule that is different from the first.

In some examples, maintaining the logical treadmill can include generating new encryption keys on demand. For instance, the new encryption keys can be generated in response to a new erasure scope parameters being created. For instance, a user can generate a request for a generation of a new erasure scope parameters including a request for a binding key and a scope timer indicating a time for which the binding key should be available. The logical treadmill can generate a new encryption key with a deletion timestamp corresponding to the amount of time for which the scope timer indicates that the binding key should be available.

A system wide TTL can be used to determine when each key should expire. The key expiration can be based on a set time such as minutes, hours, days, weeks, months, etc. The max TTL can vary from key to key. In some instances, a system wide TTL can be reconfigured. Some keys can be added to the logical treadmill after a reconfiguration and thus have different TTL. The system wide TTL can serve as a backup TTL that guarantees that no matter the key's individual expiration time, the key will be destroyed within one hour (or some other predicted unit of time) of the system wide TTL.

In some implementations, maintaining the logical treadmill can include deploying multiple distributed server processes. Each of the server processes can maintain key material and execute a loop for removal of the key material from memory upon the earlier of the receipt of a shred-now request or the deletion timestamp. The multiple distributed server processes can be located within the same physical region. The shred loop described above will be discussed in more detail related to FIG. 9.

At operation 304, processing logic can provide an interface that grants cryptographic oracle access to the encryption keys on the encryption key treadmill using a logical treadmill. For instance, each encryption key can have a deletion timestamp indicating when the key will be deleted from the treadmill (e.g., the logical treadmill, the encryption key treadmill). The encryption keys can be made available according to the first predetermined schedule and destroyed according to a second predetermined schedule different from the first predetermined schedule. The deletion timestamp can indicate a maximum TTL before expiration.

The one or more processors can be configured to delete the keys on the treadmill based on determining that the key on the treadmill is the binding key of an erasure scope parameters associated with a shred-now request. If a shred-now request is not received, the one or more processors can delete the keys on the treadmill based on comparing the deletion timestamp for each encryption key to a current time. The processors can remove a given key from the logical treadmill when the deletion timestamp is equivalent to or later than the current time.

At operation 306, processing logic can obtain data including an erasure scope parameters, wherein the erasure scope parameters includes (i) a binding key including an ephemeral key that is specific to the erasure scope parameters and (ii) a scope timer. The scope timer can include an indication of a duration of time for which the resource data should be accessible. The binding key used to encrypt the resource data is selected from the logical treadmill based on an amount of time remaining between a current time and the deletion timestamp. The amount of time remaining can correspond to the scope timer (e.g., indicated by the client).

In some instances, selecting the binding key can include determining an encryption key on the logical treadmill that is set to expire soon. The computing system can generate a new encryption key with a later expiration time. The new encryption key can be the selected binding key for the erasure scope parameters. The scope timer can include an origin deadline, a reconstruction deadline, a share expiration, and a tentative reclamation time.

At operation 308, processing logic can obtain resource data. The resource data can be obtained from a client computing system. The resource data can be accompanied by an encryption request can indicate a scope timer. The scope timer can include a duration of time for which the resource data should be accessible. The key used to encrypt the data can be selected from the treadmill based on an amount of time remaining between a current time and the deletion timestamp. The amount of time remaining can correspond to the duration of time indicated by the client. In some instances, a new encryption key is generated on the treadmill that has an expiration time equal to the deletion timestamp in the scope timer.

At operation 310, processing logic can encrypt the resource data using the binding key. As described herein, the resource data can be bound to the erasure scope parameters through a wrap/unwrap interface. By way of example, a user can provide data indicative of a request to allocate an erasure scope parameters to a particular set of data. The server computing system can locate the binding key associated with the erasure scope parameters (in some instances the binding key must be reconstructed by a distributed erasure scope parameters backing system) and can wrap the data with the encryption key. Before the expiration time associated with the scope timer, the secret shares of the binding key can be obtained to reconstruct the binding key and the associated data can be unwrapped (e.g., unencrypted or reconstructed).

For instance, encrypting the resource data using the binding key can include locating one or more binding key secret shares; reconstructing the binding key; and encrypting the resource data using the binding key. In some instances, the resource data is encrypted as it is created. For instance, in an example private pipeline service, as intermediate data is generated it can be encrypted with the binding key associated with the erasure scope parameters. Thus, the encrypted resource data will be crypto-shredded, at the latest, at the time of the expiration of the binding key or, at the earliest, upon receipt of a shred-now request.

At operation 312, processing logic can obtain data indicative of a shred-now request. For instance, the shred-now request can be a request obtained from a client device for a shred-now operation to be initiated. As described herein, a client device can obtain user input indicative of a shred-now request. Additionally, or alternatively, a shred-now request can be generated responsive to the completion of a task. For instance, erasure scope parameters can be utilized in the context of private pipeline service. The private pipeline can be associated with a one or more of client devices. In some instances, each client device can have a respective associated erasure scope parameters. The private pipeline service can determine that an entire private pipeline process associated with an erasure scope parameters has been completed and that data (e.g., including intermediate generated data) is no longer needed. In response to determining that the process has completed, and the data is no longer needed, the binding key associated with the erasure scope parameters can be deleted. The memory associated with the erasure scope parameters and associated data can be marked as available for reclamation based on the deletion of the binding key and associated data.

At operation 314, processing logic can delete, in response to obtaining the data indicative of the shred-now request, the binding key. As described herein, deleting the binding key can be a hard cryptographic deletion. For instance, the binding key can be located and written over with random data. By writing over the binding key with random data, the binding key is unable to be reconstructed and thus the data that has been encrypted with the binding key is incapable of being unwrapped or unencrypted. In some instances, this deletion is so strong that another party would have to guess what the data is in order to access the data. Thus, this method results in a strong, on demand deletion across a distributed system.

In some implementations, the deletion can be performed as a distributed operation (e.g., as described in FIG. 9). This distributed deletion can be referred to as a shred loop. The execution of the shred loop and replication of the key treadmill can be coordinated by a distributed lock service. The shred loop can globally delete all keys of the treadmill associated with an erasure scope parameters associated with the shred-now request. For instance, the shred loop can delete all records of keys from the key treadmill and each server can also evict a copy from memory. Once the key is shredded and the copies of the key are erased from memory, data encrypted by the key can no longer be accessed. In addition, the shred loop can append a new key with an availability time that can be indicated by an availability timestamp. The availability timestamp can be equal to a current time of a global clock and can be added to the end of the treadmill.

In some instances, the treadmill can expose a read-only interface, e.g., through a remote procedure call (RPC) structure, providing access to ephemeral keys on the treadmill. The interface can implement primary cryptographic operations. The operations can include a wrap operation that wraps a short data blob using an encryption key on the key treadmill and an unwrap operation that unwraps ciphertext produced by the wrap operation if the wrapping key is still available.

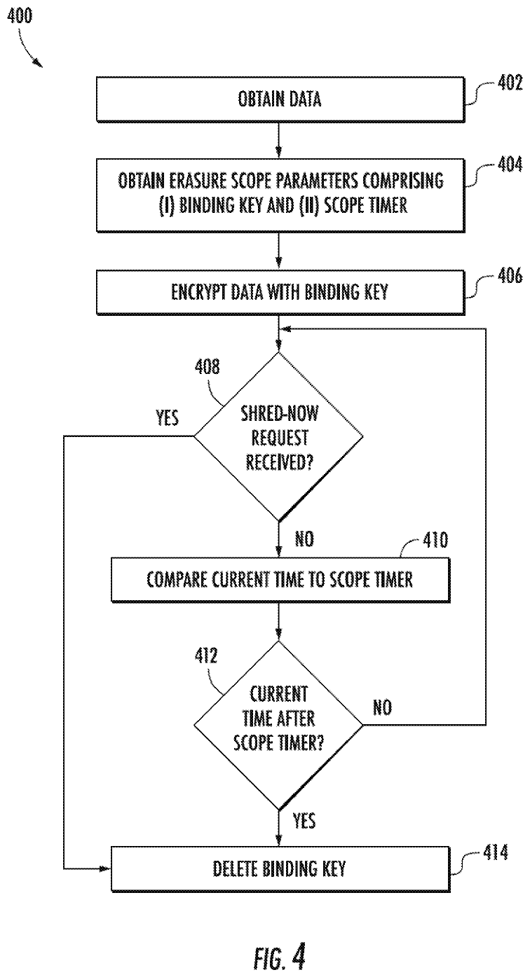

FIG. 4 depicts an example flow diagram of flow 400. Flow 400 can include obtaining data at ACT 402. At ACT 404, flow 400 can include obtaining erasure scope parameters including a binding key and a scope timer. At ACT 406, flow 400 can include encrypting the obtained data with the binding key of the erasure scope parameters.

At ACT 408, the system can determine if a shred-now request has been received. If a shred-now request has been received, the computing system can proceed to locate one or more binding key shares and destroy the binding key shares. For instance, by locating the binding key in a devices' memory (e.g., RAM) and writing over the memory space with random data. If a shred-now request has not been received, the computing system can, at ACT 410, compare the current time to the scope timer of the erasure scope parameters. For instance, the computing system can compare the current time to an expiration time associated with the erasure scope parameters. This can be performed on a single device or across multiple devices that each have one of a one or more of key shares.

At ACT 412, the computing system can determine if the current time is after the expiration time associated with the scope timer. In some instances, the current time is not after the expiration time associated with the scope timer. In these instances, flow 400 can return to 408 to determine if a shred-now request has been received. This process can be repeated until a shred-now request is received and the process proceeds to ACT 414 to delete binding key or until at ACT 412 the current time is determined to be after the expiration time associated with the scope timer. If at ACT 412, the current time is determined to be after the scope timer, ACT 414 is initiated, and the binding key is deleted. At this point, the data that was encrypted with the binding key is rendered computationally infeasible to recover (e.g., hard deletion has occurred).

FIG. 5 to FIG. 8 depict an example cryptographic key treadmill (logical treadmill, encrypted key treadmill) at various times. For Instance, FIG. 5 depicts a state of the logical treadmill at time 1. The logical treadmill can include multiple keys (e.g., key 1 502, key 2 504, and key 3 506) as well as each key's respective availability timestamp and deletion timestamp. For instance, key 2 504 can have a deletion timestamp associated with key 2 deletion time 508.

The computing system can determine, based on user input, that a user wants to generate an erasure scope parameters to bind a set of data to the erasure scope parameters. For instance, the computing system can determine a key that is close to expiration (e.g., has an expiration time that is within a threshold time of the actual time (e.g., globally measured time)). The computing system can overwrite the storage location associated with key 1 502 with a new cryptographic key that has a longer amount of time to the expiration time. For instance, computing systems can choose key 2 504 as the binding key. In some instances, the computing system can generate key 2 504 as a new key to be used as the binding key.

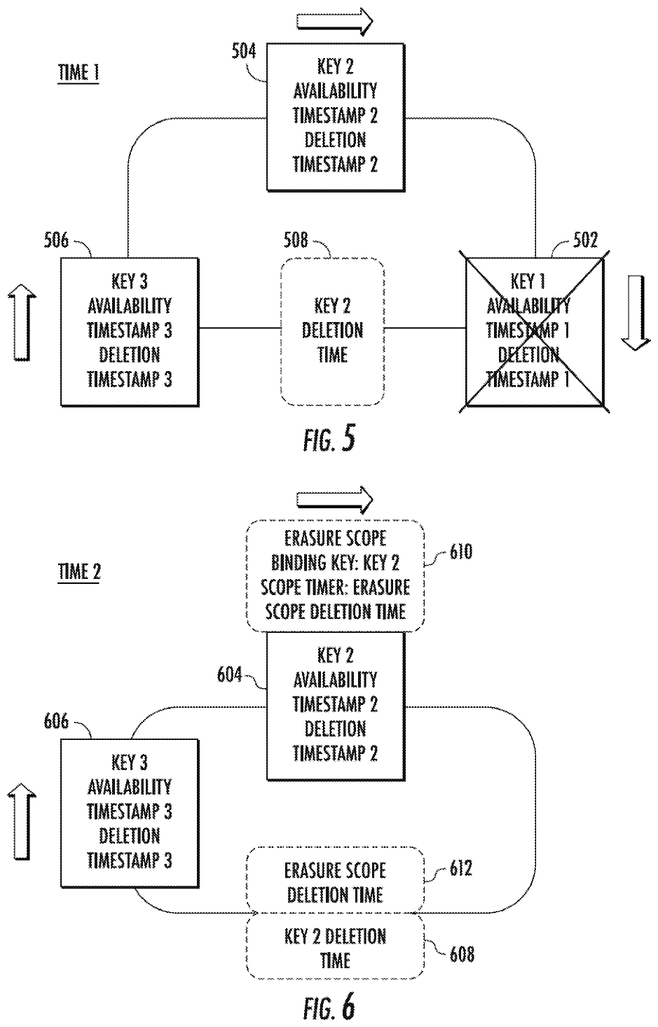

As depicted in FIG. 6, at time 2, key 1 (e.g., key 1 502) can be removed from the treadmill. There can exist a key 2 604 which has been selected as the binding key for the erasure scope parameters 610. The erasure scope parameters 610 can include an indication of key 2 604 as the binding key and can indicate a user selected or user provisioned scope timer.

A scope timer can include an origin deadline, a reconstruction deadline, a share expiration, and a tentative reclamation time. The state of the treadmill timer and related scope timers can include a definitive state being determined using a majority rule. A treadmill timer entry is considered to be present if it is written to a majority of cells (e.g., as depicted in FIG. 9).

The origin deadline can include a unique user identifier corresponding to a write operation that produces the erasure scope parameters share. For instance, the origin deadline can include a timestamp of when the erasure scope parameters were generated.

The reconstruction deadline can include a time after which the encryption treadmill key cannot re-generate the data bound to the erasure scope parameters without a threshold of valid backing shares. The erasure scope parameters ID, isolation boundary, reconstruction deadline can uniquely but privately ephemerally identify the binding key. Between the origin deadline and the reconstruction deadline, the encryption key associated with the erasure scope parameters and the data wrapped with the encryption key can be located, reconstructed, and unwrapped.

The share expiration can include a time after which this particular erasure scope parameters 610 will be crypto-shredded. The share expiration can correspond directly to the expiration of the binding key associated with the erasure scope parameters that the share is a member of. For instance, the erasure scope parameters deletion time 612 can be equal to, or within a threshold amount of time of, key 2 deletion time 608. As described herein, the data that has been wrapped with the erasure scope parameters binding key can be deleted on demand as of a time of receipt of a shred-now request. However, if a shred-now request is not received before the expiration time, the encryption key will be deleted as of the share expiration time.

The tentative reclamation time can include a time after which the entire erasure scope parameters can be reclaimed. For instance, a tentative reclamation time can include a time at which a new encryption key can be generated and written over by a new erasure scope parameters.

The computing system can select key 2 604 as the key based on the erasure scope parameters deletion time 612 and the key 2 deletion time 608 being the same or within a threshold time of one another.

In addition, or alternatively, to creating a new cryptographic key for an erasure scope parameters, the binding key can further be encrypted using a second encryption key that is on the logical treadmill. The second encryption key can be selected based on a comparison of the scope time (e.g., expiration time) and the expiration time of the cryptographic key. This serves as an additional layer of security that provides for crypto-shredding of the binding key as of the set expiration time associated with the second encryption key.

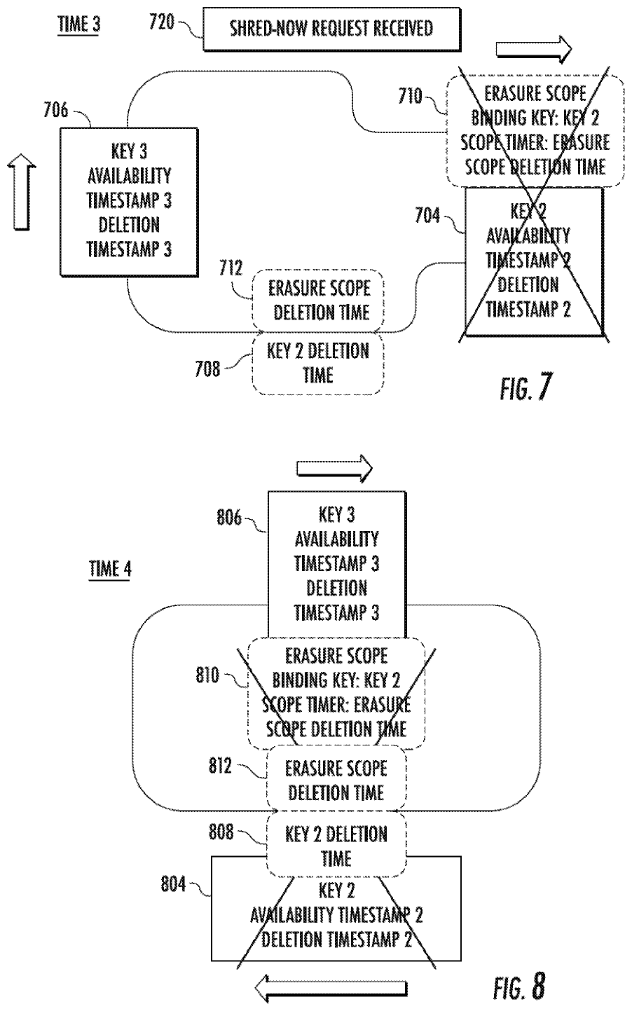

FIG. 7 depicts an example time 3 where a shred-now request 720 is received. For instance, in response to obtaining a shred-now request 720, the computing system can automatically locate the binding key associated with erasure scope parameters 710 (e.g., via one location or multiple locations as described with regard to FIG. 9) and delete the binding key. This can render any data encrypted by the binding key as computationally infeasible to recover. For instance, this can include deleting key 2 704 that has served as the binding key for erasure scope parameters 710.

As described herein, the shred-now request 720 can be received before the current time (e.g., time 3) is equal to the time associated with erasure scope parameters deletion time 712 and key deletion time 708. Key 3 706 can continue to progress on the logical treadmill.

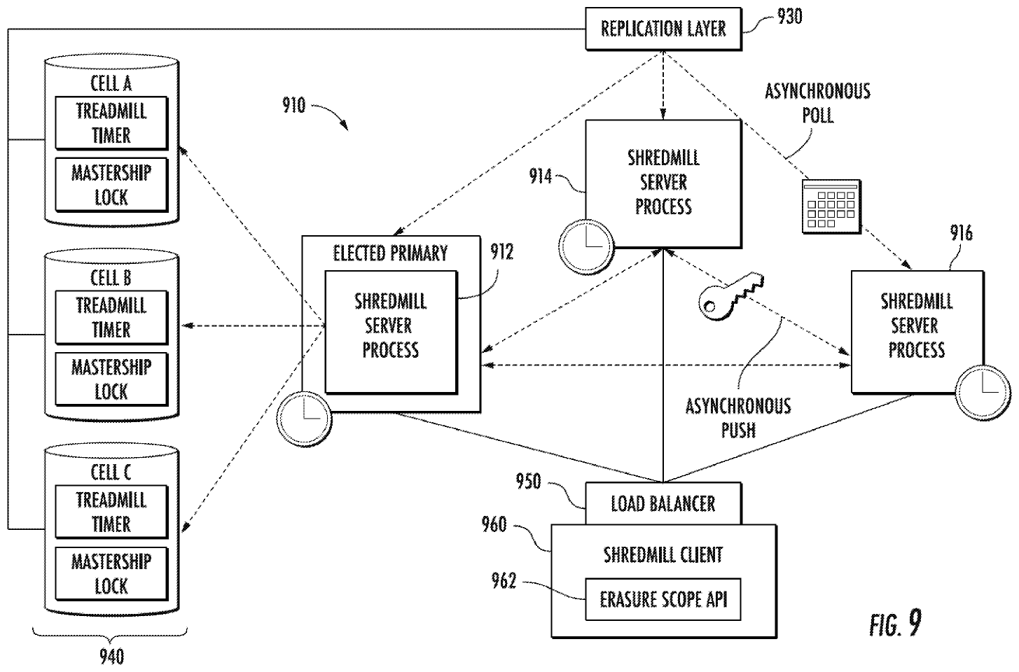

FIG. 8 depicts an example time 4 where a shred-now request is not received, but instead, the erasure scope parameters 810 and associated key 2 804 make it to a current time (e.g., time 4) that is equal to, or past, the key 2 deletion time 808 and erasure scope parameters deletion time 812. By comparing the current time to the key 2 deletion time 808, the system can determine that the current time has passed the key 2 deletion time 808. In response, the computing system can delete key 2 804 thus rendering the data bound to that erasure scope parameters 810 computationally infeasible to determine. Key 3 806 can continue to progress on the logical treadmill.

As described herein, in some implementations the cryptographic key can be distributed over one or more processes, devices, or spaces. For instance, as described herein, the key can be distributed across multiple devices in a secret sharing manner. For instance, the secret sharing can include Shamir secret sharing. The secret sharing can include one or more locations where n/2+1 of the shares must be in agreement to reconstruct the binding key (e.g., and access any encrypted data). As depicted in FIG. 9, the computing environment can include distribution across devices.

FIG. 9 illustrates an example system in which the encryption key treadmill is distributed across multiple nodes. For example, as shown, region 910 includes multiple nodes 912, 914, 916. The nodes can be, for example, servers, replicas, or any other computing devices operating in a distributed system. In this example, the nodes are instances of a server process. As described herein, the terms server process, replica, and node can be used interchangeably.

The nodes can receive requests from a shredmill client 960. The requests can be distributed amongst the nodes 912-916 by load balancer 950. The requests can be, for example, to encrypt data. The nodes 912-916 encrypt the data using keys from the encryption key treadmill and return the data back to the shredmill client 960 via erasure scope parameters API 962.

The nodes 912, 914, 916 are communicatively coupled to a distributed lock service 940 including Cell A, Cell B, Cell C. For example, the nodes 912-916 can be coupled to the distributed lock service 940 through a replication layer 930. Through the replication layer 930, updates can be pushed to all nodes 912-916. The updates can include, for example, shred-now requests, key schedules, as opposed to key material. The updates can be pushed synchronously or asynchronously to the nodes 912-916.

The encryption key treadmill state consists of (i) a public treadmill timer which times events on the encryption key treadmill and (ii) private key material for each key on the treadmill. The public treadmill timer is replicated using the distributed lock service 940. Within a given regionalized deployment, treadmill key material is replicated and strictly isolated to instance RAM, such as by using lightweight synchronization over protected channels.

The distributed shred loop which keeps the treadmill running is implemented using primary election and local work at each server instance. This primary can be the sole replica responsible for propagating shred-now requests or new key versions and setting a system-wide view of treadmill state. All other nodes watch the treadmill files in distributed lock service 940, and then perform work to locally shred keys and synchronize with peers if local loss or corruption is detected.

The system elects a single primary to perform treadmill management. In the example of FIG. 9, node 912 is elected as primary. For example, the elected primary node 912 pushes a definitive state to the distributed lock service 940 and pushes a description of what keys exist to the distributed lock service 940. The election of the primary node 912 can enforce that there is only ever a single writer for all timer replicas. Timer files will be written to by a single primary replica and will be world-readable, available to be watched via the replication layer 930.

In distributed lock service cells A-C, the primary lock box keeps a consistent and authoritative view of which server process is primary. As the nodes 912-916 participate in a primary election protocol, this view is updated, and then the nodes are able to definitively determine if and when they are primary.

In some examples, the primary keeps a definitive key schedule for use by the nodes 912-916. The schedule can define when particular keys become available and when they should be destroyed. The primary node 912 uses the definitive key schedule to update the logical treadmill.

By fixing key generation frequency and enforcing that only one new key can be considered ‘propagating’ at a time, schedule predictability is implemented in the shred loop. The schedule predictability can be provided through one or more parameters. Such parameters can include, for example, that at least one key is propagating through the system at a given instant. Further, each key has a fixed TTL, determined by the primary replica which added it. Keys are added to the end of the schedule in order of increasing expiration time. Subsequent key expiration times are separated by a fixed time to shred (TTS). Subsequent key availability intervals either overlap or have no time delay between them.

A key on the treadmill is considered in distribution if the current time is less than the availability time for the key. The system can, in some examples, enforce that at least one key will be in distribution at a given time by means of the distributed shred loop.

The primary node 912 wakes up frequently to check if a new key should be added to the treadmill or if a shred-now request has been received. If a new key should be added, the primary node 912 will push an update to all nodes 914, 916. For example, such updates can be pushed by the primary node 912 through the distributed lock service 940 and the replication layer 930. The updates can include a key schedule, as opposed to key material. All nodes 912-916 wake up frequently to check if they are missing an update according to the current time. If they missed an update, they attempt to synchronize with a randomly chosen neighbor. For example, if node 916 wakes up and determines, based on the global clock, that it missed an update, the node 916 can attempt to synchronize with the node 914. For example, the node can asynchronously poll a peer node for the key material. The node can determine that it missed an update by, for example, resolving a local copy of the treadmill timer through the replication layer 930, and checking whether the node has the key material for all keys in the timer. If it does not, then the node can synchronize with a peer.

If a shred-now request has been received, the primary node 912 will push an update to all nodes 914, 916. For example, such updates can be pushed by the primary node 912 through the distributed lock service 940 and the replication layer 930. The updates can include a shred-now request. All nodes 912-916 wake up frequently to check if they are missing an update according to the current time or a state of a neighbor node. For instance, if node 916 wakes up and determines, based on the state of node 912 or 914, that it missed an update, the node 916 can attempt to synchronize with a neighbor node 914, 912. For example, the node by asynchronously polls a peer node for key material. The node can determine that it missed an update by, for example, resolving a local copy of the treadmill timer through the replication layer 930, and checking whether the node has the key material for all keys in the timer. Or if the node has key material for keys no longer in the timer. If the node has key material for a key not in the neighbor nodes, the node can determine that a shred-now request was received and that the key associated with the shred-now request should be deleted.

Public treadmill state will be definitively replicated across cells A-C in the distributed lock service 940. While three cells are shown in FIG. 9, it should be understood that the distributed lock service 940 can include any number of cells. For each cell, a serializable data structure containing a treadmill timer will be written to a file. The serializable data structure indicates an origin deadline, a reconstruction deadline, a share expiration, and a tentative reclamation time.

The treadmill state can be coordinated through an internal administrative interface exposed by the nodes 912-916. The interface can be used to coordinate treadmill maintenance and synchronization. The internal administrative interface will respond only to server instances in the same region 910 (e.g., regionalized deployment). This interface supports operations including an update operation, used by a primary to push treadmill state to non-primary replicas, and an inspect operation, used by all replicas for synchronization. The update takes a treadmill schedule and a map of key material and installs both in the local replica. The inspect operation returns the locally known treadmill schedule and all known key material.

At each node 912-916, a replica shred loop runs frequently. The replica shred loop performs mostly local work to shred expired keys, detect loss/corruption, and receive missed updates. For example, the replica shred loop can be run to resolve the current treadmill state from the distributed lock service 940. This information can be provided via an asynchronous replication layer watcher registered for the associated files. The replica shred loop can further evict any key known to the replica that is not present in the schedule or which has expired. For all non-expired keys in the schedule, the replica watch loop can verify that non-corrupt key material is available for the key. For example, internally, each server can maintain a checksum which can be used for this verification. If unavailable or corrupt key material is detected, the inspect operation can be performed. For example, the node can inspect one or more randomly chosen peers and search each peer's state for the desired key material.

At the elected primary node 912, a primary shred loop runs, and performs mostly local work to correct global schedule loss and advance the schedule. Following the regularly scheduled replica loop, the primary node 912 will advance the schedule such that it is up to date at a target time and contains a schedule buffer. The primary instance takes the target time as the execution timestamp of the current shred loop cycle and corrects any missing or corrupt keys in the schedule. Correcting missing or corrupt keys can include, for example, generating new key material and updating the key hash for any key which should be available at any point within the schedule buffer of the target time. The primary node further checks whether the schedule is up to date already at the target time plus the schedule buffer. For example, the primary checks whether some key in the schedule is propagating. If no key is propagating, the primary node will advance the schedule and push the update.

Advancing the schedule can include executing a procedure, wherein if the schedule is empty, a key is added. The added key can be added with an availability time equivalent to the target time, plus a time to shred, minus a TTL. The added key can be added with a deletion time equivalent to the availability time plus the TTL. The procedure for advancing the schedule can further include, while the last key in the schedule is not propagating at the target time, calculating an absolute deletion time and a distribution and availability time for the new key. The absolute deletion time can be calculated using the last deletion time plus the time to shred. The availability time can be calculated as a maximum of a last availability time, or the deletion time minus the TTL. The procedure can further remove all keys from the schedule which are expired by the target time.

In some instances, the procedure can include associating a key with an erasure scope parameters and scope timer. The erasure scope parameters and scope timer can be included in advancing the schedule or pushing an update-to-update treadmill files in the distributed lock service.

Pushing the update can include updating the treadmill files in the distributed lock service 940. The updated treadmill state, with both key schedules and key material, can be pushed to all nodes 912-916 with an update call to each. In some cases, a fraction of the nodes can miss the update. In this event, those nodes will self-correct in the next local replica shred loop. The primary node can perform server authorization checks before completing the push and/or before accepting requests to inspect. For example, the primary node can apply a security policy to the RPC channel between peers, requiring that the peers authenticate as process servers in the system in the same regionalized deployment. For example, a shred-now request can be pushed to the nodes 912-916 in the distributed lock service. A node can miss the shred-now request but can be self-corrected in the next local replica shred loop. As long as a threshold number of nodes process the shred-now request (e.g., n/2+1 nodes), the associated key will not be able to be reconstructed thus resulting in successful crypto-shredding of the underlying encrypted data associated with the erasure scope parameters.

As an externally facing service, the system exposes a cryptographic oracle interface to ephemeral keys in a given regionalized deployment as an RPC infrastructure service. The interface can support ephemeral envelope encryption via the wrap and unwrap operations for RPCs, discussed above. Ephemerality can be guaranteed by the encryption key treadmill.

Each node 912-916 in the system will have local access to the encryption key treadmill timer, such as via the distributed lock service 940 and updates from the primary node 912. Each node 912-916 will further have local access to encryption key material obtained through peer synchronization.

The cells A-C of the distributed lock service 940 can store a timer which relates key hashes to events for those keys. The timer is distributed to the nodes 912-916 via the replication layer 930. Each node 912-916 can store a map relating key hashes to key material. When executing the wrap operation to encrypt data, keys can be resolved by TTL, such as by searching the map according to deletion time. When executing the unwrap operation to decrypt the data, a node can consult its locally stored map to resolve the keys.

On each wrapping operation, the replica will resolve a key to use on the treadmill through a policy which uses the first key in the schedule with a deletion timestamp occurring after the expiration time. Using this key, the system will encrypt an envelope containing plaintext. In addition to the wrapped key and the key name, the system will return (i) the hash of the key used to produce the ciphertext, (ii) the region of the instance which served the request, and (iii) the final expiration, as determined by the key used for wrapping.

On each unwrapping request, the server instance will use the key hash to resolve the appropriate key. This key will be used to unwrap ciphertext. If unwrapping is successful, this will yield key bytes and a fingerprint authenticating the plaintext origin. If a user making the unwrapping request satisfies the access policy, the plaintext is returned to the user.

The system implements a region-aware security model. If the system is compromised in one region, an attacker cannot obtain key material managed by the system in any other region. All key material synchronization endpoints will only serve instances in the same region, and every primary will refuse to push to invalid peers. Moreover, if the system is compromised in one region, an attacker cannot use the compromised instance to unwrap or re-derive anything wrapped or derived in another region.

An example implementation of this disclosure can include a private pipeline service. The private pipeline service can be associated with multiple customers with one or more related client devices. In the example implementation, each customer's data can be contained in a single erasure scope parameters. Alternatively, each customer can have multiple erasure scope parameters defined to cover different sets of data. Upon receipt of a shred-now request from the customer, the computing system can reliably shred all data belonging to specified erasure scope parameters of the customer.

As described herein, a private pipeline service can be associated with multiple customers. Each customer can utilize an erasure scope parameters to group data (e.g., resources, documents, etc.) which can be shredded on command by shredding the associated erasure scope parameters. For instance, the erasure scope parameters can be shredded by destroying the binding key associated with the respective erasure scope parameters. For instance, an erasure scope parameters can be created for each customer. Any ciphertext produced by Shredmill (e.g., the distributed cryptographic key treadmill) for a respective customer can be encrypted with the binding key associated with the respective erasure scope parameters. At the time equal to the earlier of the receipt of a shred-now request or an expiration time the computing system can destroy the erasure scope's binding which in turn destroys all user data bound by the binding key of the erasure scope parameters.

Erasure scope parameters can include serialized data structures that include a binding key and a scope timer. The binding key can identify a cryptographic key from the encryption key treadmill that is to be used as the key to encrypt data associated with the customer associated with the erasure scope parameters. The scope timer can include several timing events including a tentative expiration time. In some implementations, the erasure scope parameters can be contained by an erasure scope parameters namespace that additionally configure an application policy associated with users that can operate on scopes (e.g., allocate scopes, send a shred-now request, reclaim scopes) and a storage policy that determines which physical resources (e.g., RAM) back the erasure scope parameters. For instance, the erasure scope parameters can be backed in a three-cell system as described in FIG. 9. In some instances, a private pipeline service can run pipelines for n number of users. In this multi-user implementation, each user can be associated with a unique erasure scope parameters. Each unique erasure scope parameters can include the binding key and the scope time for that erasure scope parameters.

The erasure scope parameters namespaces and erasure scope parameters can be stored in a serialized data structure that results in uniquely addressed universal resource identifier-like (URI-like) structured identifiers. The URI-like structured identifiers can include an indication of the realm or realm group associated with the erasure scope parameters, an indication of what user devices have permission to control the expiration of the erasure scope parameters, what user devices have permission to bind data to the scope, an indication of a set of cells that physically store the erasure scope parameters, and paths within each cell of the set of cells to where the erasure scope parameters are stored.

In some instances, the erasure scope parameters can be created or used in the context of an isolation boundary. The isolation boundary is resolved by the server rather than included in the erasure scope parameters namespace. An isolation boundary can be associated with defining different levels of trust between different portions of the serialized data structure.

The erasure scope parameters namespaces and erasure scope parameters can be replicated, e.g., by replication layer 930 and distributed across multiple cells in distributed lock service 940. For instance, the erasure scope parameters and erasure scope parameters namespaces can be replicated via floor (n/2+1)-of-n secret sharing across a number of cells in distributed lock service 940 in the same isolation boundary.

Each respective erasure scope parameters namespace can be backed by a file in each backing cell (cell A, cell B, cell C). Each erasure scope parameters namespace backing file can contain multiple erasure scope parameters shares. For instance, the erasure scope parameters namespace backing file can include a sequence of aligned erasure scope parameters shares. The local share of an erasure scope parameters #i can correspond to the ith aligned scope in the file. In some implementations, an erasure scope parameters namespace can include multiple scopes. For instance, a single erasure scope parameters namespace could be associated with thousands, millions, or billions or erasure scope parameters.

In some implementations, each erasure scope parameters share can be a serialized data structure including 68-byte blocks. For instance, the 68-byte erasure scope parameters can include 32-bytes associated with the share timer, 32 bytes associated with the encrypted binding key share, and 4-bytes dedicated to an aggregate checksum to detect corruption in storage. The 32 bytes of timestamps can definitely parameterize the destruction of the erasure scope parameters.

For instance, the share timer can include 8-bytes for each of the following: origin deadline, reconstruction deadline, share expiration, and tentative reclamation time.

The encrypted binding key share can encode a binding key share that can be used to recover the definitive binding key for the scope. For instance, the binding key share can be a 32-byte floor (n/2+1) of n share of a cryptographic key that is ephemerally encrypted with a share expiration.

By storing the erasure scope parameters in a serialized data structure with a set number of integers, specific erasure scope parameters can be relatively easy to locate. For instance, to resolve a share of ith scope in the erasure scope parameters namespace file, the computing system can open the erasure scope parameters namespace file, seek to the (i)*68th byte, and read 68 bytes. While the present example embodiment uses a specified number of bytes. This is for exemplary purposes only and is not meant to be limiting. The erasure scope parameters namespaces can include any number of bytes.

The erasure scope parameters namespace and scope identifiers can be public and specified in cleartext (e.g., unencrypted shared data). The destruction timer associated with the backing files can be considered public and specified in cleartext.

Binding keys, however, are not public. The binding keys can either be authenticated or can be encrypted using a modified secret sharing technique. For instance, as described herein, this method can be utilized on large scales of data (e.g., orders of millions or billions of erasure scope parameters). As such, storage cost and payload overhead are of concern. Thus, a compact method that relies upon secret sharing can be utilized to allow for share validation upon reconstruction without requiring additional storage to be utilized.

FIG. 10 depicts a block diagram of an example computing system 1000 that determines privacy execution actions based on context data associated with a user device according to example embodiments of the present disclosure. The computing system 1000 includes a user computing device 1002, and a server computing system 1004 that are communicatively coupled over a network 1080.

The user computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1002 includes processors 1012 and memory 1014. The processors 1012 can be any suitable processing device (e.g., a processor core, a microprocessor, an ASIC, an FPGA, a controller, a microcontroller, etc.) and can be one processor or a one or more of processors that are operatively connected. The memory 1014 can include non-transitory computer-readable storage media, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

In some implementations, the user computing device 1002 can include input component 1020 and erasure scope parameters data 1030. Input component 1020 can include erasure scope parameters input 1022 or shred-now API 1024. Erasure scope parameters data 1030 can include one or more erasure scope parameters 1032.

The input components 1020 can receive user input. For example, the input component 1020 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input. Erasure scope parameters 1032 can include a one or more of erasure scope parameters. The erasure scope parameters 1032 can include binding keys 1034 and scope timers 1036.

The server computing system 1004 includes processors 1042 and a memory 1044. The processors 1042 can be any suitable processing device (e.g., a processor core, a microprocessor, an ASIC, an FPGA, a controller, a microcontroller, etc.) and can be one processor or a one or more of processors that are operatively connected. The memory 1044 can include non-transitory computer-readable storage media, such as RAM, ROM, EEPROM, EPROM, flash memory devices, magnetic disks, etc., and combinations thereof. The memory 1044 can store data 1046 and instructions 1048 which are executed by the processor 1042 to cause the server computing system 1004 to perform operations.

In some implementations, the server computing system 1004 includes or is otherwise implemented by server computing devices. In instances in which the server computing system 1004 includes plural server computing devices, such server computing devices can operate according to sequential computing architectures, parallel computing architectures, or some combination thereof.

Server computing system 1004 can include logical treadmill 1050 and shred-now execution component 1056. Logical treadmill 1050 can include encryption keys 1052 and deletion timestamps 1054 associated with each of the encryption keys 1052. As described herein, the encryption keys 1052 can be created and destroyed based on a schedule or based on receiving a request to allocate an encryption key to an erasure scope parameters or a shred-now request to delete the binding key of an erasure scope parameters. Shred-now execution component 1056 can locate the encryption key that has been selected as the binding key for the respective erasure scope parameters. The shred-now execution component 1056 can locate the binding key and write over it with random data.

The network 1080 can be any type of communications network, such as a local area network (e.g., intranet), wide area network (e.g., Internet), or some combination thereof and can include any number of wired or wireless links. In general, communication over the network 1080 can be carried via any type of wired or wireless connection, using a wide variety of communication protocols (e.g., TCP/IP, HTTP. SMTP, FTP), encodings or formats (e.g., HTML, XML), or protection schemes (e.g., VPN, secure HTTP, SSL).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for case of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

What is claimed is:

1. A computer-implemented method, comprising:
obtaining, by a computing system, data comprising erasure scope parameters, wherein the erasure scope parameters comprise a binding key and a scope timer;
obtaining, by the computing system, resource data;
encrypting the resource data using the binding key;
obtaining data indicative of a shred-now request; and
deleting, in response to obtaining the shred-now request, the binding key.

2. The computer-implemented method of claim 1, wherein the binding key is stored across a plurality of devices by distributing a binding key secret share to each device of the plurality of devices.

3. The computer-implemented method of claim 1, wherein the binding key comprises an ephemeral key that is specific to the erasure scope parameters and wherein the binding key is a unique encryption key associated with a logical treadmill, wherein the method comprises:
maintaining a logical treadmill of multiple unique encryption keys that are made available and destroyed according to a predetermined schedule, wherein each of the unique encryption has an associated deletion timestamp;
providing an interface that grants cryptographic oracle access to the encryption keys on the treadmill using a logical treadmill; and
obtaining the scope timer, wherein the scope timer comprises an indication of a duration of time for which the resource data should be accessible, wherein the binding key used to encrypt the data is selected from the logical treadmill based on an amount of time remaining between a current time and the deletion timestamp, the amount of time remaining corresponding to the scope timer.

4. The computer-implemented method of claim 3, wherein maintaining the logical treadmill comprises deploying a plurality of distributed server processes, each of the plurality of server processes maintaining key material and executing a loop for removal of the key material from memory at the deletion timestamp.

5. The computer-implemented method of claim 4, wherein deleting the binding key comprises executing a loop for removal of the key material from the memory at the time of receipt of the shred-now request.

6. The computer-implemented method of claim 4, wherein encrypting the resource data using the binding key comprises:
locating one or more binding key secret shares;
reconstructing the binding key; and
encrypting the resource data using the binding key.

7. The computer-implemented method of claim 1, wherein the deleting the binding key comprises:
locating one or more binding key secret shares; and
writing over the one or more binding key secret shares storage location with random data.

8. The computer-implemented method of claim 1, wherein the erasure scope parameters are associated with an erasure scope namespace that comprises the binding key, the scope timer, an identification of one or more authorized user devices to transmit shred-now requests, and a storage policy associated with one or more storage locations associated with secret sharing of the binding key.

9. The computer-implemented method of claim 1, wherein deleting the binding key results in the binding key being computationally unrecoverable.

10. The computer-implemented method of claim 1, wherein the scope timer comprises a time to live, and wherein the shred-now request is received before the time to live.

11. The computer-implemented method of claim 1, wherein the binding key is stored across n number of devices, and wherein to unwrap data associated with the binding key, n/2+1 of the n number of devices must be accessible.

12. The computer-implemented method of claim 1, wherein the erasure scope parameters are stored in a bit layout comprising the scope timer and an encrypted binding key share.

13. The computer-implemented method of claim 12, wherein the scope timer comprises an origin deadline, a reconstruction deadline, a share expiration, and a tentative reclamation time.

14. The computer-implemented method of claim 12, wherein the encrypted binding key share comprises a key identifier and an expiration time.

15. A computing system, comprising:
one or more processors; and
one or more computer-readable media storing instructions that are executable to cause the one or more processors to perform operations, the operations comprising:
obtaining, by the computing system, data comprising an erasure scope parameters, wherein the erasure scope parameters comprises a binding key and a scope timer;
obtaining, by the computing system, resource data;
encrypting the resource data using the binding key;
obtaining data indicative of a shred-now request; and
deleting, in response to obtaining the shred-now request, the binding key.

16. The computing system of claim 15, wherein the binding key comprises an ephemeral key that is specific to the erasure scope parameters.

17. The computing system of claim 16, wherein the binding key is a unique encryption key associated with a logical treadmill, wherein the operations comprise:
maintaining a logical treadmill of multiple unique encryption keys that are made available and destroyed according to a predetermined schedule, wherein each of the unique encryption has an associated deletion timestamp;
providing an interface that grants cryptographic oracle access to the encryption keys on the treadmill using a logical treadmill; and
obtaining the scope timer, wherein the scope timer comprises an indication of a duration of time for which the resource data should be accessible, wherein the binding key used to encrypt the data is selected from the logical treadmill based on an amount of time remaining between a current time and the deletion timestamp, the amount of time remaining corresponding to the scope timer.

18. The computing system of claim 17, wherein maintaining the logical treadmill comprises deploying a plurality of distributed server processes, each of the plurality of server processes maintaining key material and executing a loop for removal of the key material from memory at the deletion timestamp.

19. The computing system of claim 18, wherein deleting the binding key comprises executing a loop for removal of the key material from the memory at the time of receipt of the shred-now request.

20. One or more non-transitory computer readable media storing instructions that are executable by one or more processors to perform operations comprising:
maintaining a logical treadmill of multiple unique encryption keys that are made available and destroyed according to a predetermined schedule, wherein each of the unique encryption has an associated deletion timestamp;
providing an interface that grants cryptographic oracle access to the encryption keys on the treadmill using a logical treadmill;
obtaining, by a computing system, data comprising an erasure scope parameters, wherein the erasure scope parameters comprise (i) a binding key comprising an ephemeral key that is specific to the erasure scope parameters and (ii) a scope timer, wherein the scope timer comprises an indication of a duration of time for which resource data should be accessible, wherein the binding key used to encrypt the data is selected from the logical treadmill based on an amount of time remaining between a current time and the deletion timestamp, the amount of time remaining corresponding to the scope timer;
obtaining, by the computing system, the resource data;
encrypting the resource data using the binding key;
obtaining data indicative of a shred-now request; and
deleting, in response to obtaining the shred-now request, the binding key.
